(19) United States
(12) Patent Application Publication
(10) Pub. No.: US 2003/0118170 A1
(43) Pub. Date: Jun. 26, 2003

(54) Communications call routing

(76) Inventor: Anthony david Wilson, Surrey (GB)

Correspondence Address: William M. Lee, Jr., LEE, MANN, SMITH, MCWILLIAMS, SWEENEY & OHLSON, P.O. Box 2786, Chicago, IL, 60690-2786, US

(21) Appl. No.: 10/032,422

(22) Filed: Dec. 21, 2001

(51) Int. Cl. H04M 7/00

(52) U.S. Cl. 379/220.01

(57) ABSTRACT

A method and corresponding apparatus, programs, and signals for maximising the use of trunks between telecommunications network nodes (for example Private Branch Exchanges (PBX's)) whilst avoiding looping during call set-up phase. Looping avoidance is achieved by including in the call set-up request messages a trail log comprising indications of those nodes through which the call set-up message has already passed. Each node in the network can then forward the call set-up sequence for a new voice call dependent both on the local routing tables stored in each routing node and the list of previously passed nodes contained in the call set-up message, and in particular avoiding routing a received call set-up message back to a node indicated in the trail log of that set-up message.

### FIELD OF THE INVENTION

The present invention relates to methods, apparatus, programs for a computer, and signals for routing in a telecommunications network and systems incorporating the same.

### BACKGROUND TO THE INVENTION

Looping in communication systems is a well-known problem. Looping occurs when for example, in attempting to route a call between a source and a destination node via one or more intermediate nodes, a path is set up in such a way as to re-traverse a node which has already been added to the path. Whilst looping is not assured under such circumstances—a route could be established which merely crosses, rather than re-traces, itself—there is nevertheless a possibility that the same route will be followed out of the node as previously. In the worst case, the routing attempt cycles indefinitely acquiring more and more bandwidth and hence locking other calls from being made, until there are no more traffic links to allocate. At that point the network may either lock, requiring some manual intervention to clear the problem, or automatically back out of the attempt, releasing the resources for other calls to use (as for example in the ISDN “drop back on busy” feature).

One known approach to mitigate the effects of looping is to avoid reciprocal routing between nodes in the networks. This operates by defining the routes in the routing tables available to each node in such a way that a call set-up request received at node B from a given node A, cannot be routed back via the previous node, in this case node A. Whilst this approach mitigates the effects of looping back an immediately preceding node, it does not solve the wider problem of looping occurring around a cycle of three or more nodes.

### OBJECT OF THE INVENTION

The invention seeks to provide an improved method, apparatus, programs for a computer, and signals for routing in a telecommunications network so as to mitigate the problems associated with the prior art. The invention is particularly directed to, but not limited to, such improvements for networks comprising Private Branch Exchanges.

### SUMMARY OF THE INVENTION

The invention is directed to a method of maximising the use of trunks between telecommunications network nodes (for example Private Branch Exchanges (PBX's)) whilst avoiding looping during call set-up phase. Looping avoidance is achieved by including in the call set-up request messages a trail log comprising indications of those nodes through which the call set-up message has already passed. Each node in the network can then forward the call set-up sequence for a new voice call dependent both on the local routing tables stored in each routing node and the list of previously passed nodes contained in the call set-up message, and in particular avoiding routing a received call set-up message back to a node indicated in the trail log of that set-up message.

According to a first aspect of the present invention there is provided a method of routing calls in a telecommunications network routing node, the method comprising the steps of: receiving a call set-up request comprising an indication of previously passed nodes; retrieving previously stored call routing information; routing the call set-up request responsive to a comparison between the indication and the previously stored call routing information.

In a preferred embodiment, the routing node is a Private Branch Exchange.

In a preferred embodiment, the indication of previously passed nodes comprises a bit sequence, each bit of which uniquely identifies a network node.

In a preferred embodiment, the call set-up request further comprises an indication that the call set-up request relates to a non-primary routed call.

In a preferred embodiment, the indication that the call set-up request relates to a non-primary routed call precedes the trail log.

The invention is also directed to apparatus for carrying out the methods of the invention and comprising components for carrying out each step of those methods.

In particular, according to a further aspect of the present invention there is provided a call routing node, for a telecommunications network, comprising: a port arranged to receive a call set-up request comprising a trail log, from another call routing node; a store for storing call routing information; a router arranged to route the call set-up request responsive to a comparison between the trail log and the stored call routing information.

The invention also provides for a system for the purposes of telecommunications which comprises one or more instances of apparatus embodying the present invention, together with other additional apparatus.

In particular, according to a further aspect of the present invention there is provided a telecommunications network comprising at least one call routing node according to the present invention.

The invention is also directed to programs for computers arranged to perform the methods of the invention and including program portions for carrying out each function of the invention.

In particular, according to a further aspect of the present invention there is provided a program for a computer in a machine readable form for routing calls in is a telecommunications network comprising a plurality of nodes, the program comprising portions arranged to perform the steps of: receiving a call set-up request comprising a trail log; retrieving previously stored call routing information; routing the call set-up request responsive to a comparison between the trail log and the previously stored call routing information.

The invention is also directed to a signal arranged to facilitate the method of the present invention.

In particular, according to a further aspect of the present invention there is provided a telecommunications signal comprising a call set-up request comprising a trail log for use in routing the call set-up request.

In a preferred embodiment, the call set-up request further comprises an indication that the call set-up request relates to a non-primary routed call.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying Figures in which:

FIG. 1 shows a first network arrangement in accordance with the present invention;

FIG. 2 shows a second network arrangement in accordance with the present invention;

FIG. 3 shows a third network arrangement in accordance with the present invention;

FIG. 4 shows a flow diagram of a call routing method in accordance with the present invention;

FIG. 5 shows a schematic call set-up message format in accordance with the present invention.

FIG. 6 shows an example of a hierarchical network arrangement in accordance with the present invention.

FIG. 7 shows a routing method in accordance with the present invention.

### DETAILED DESCRIPTION OF INVENTION

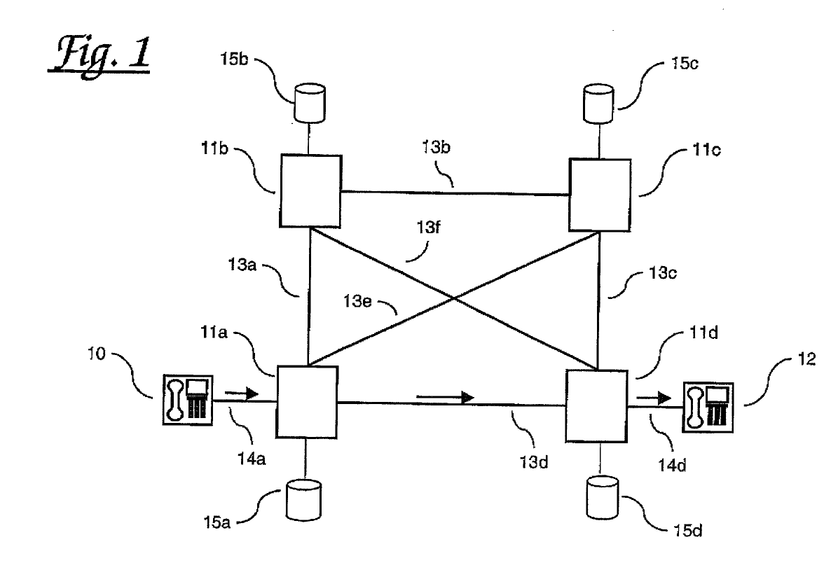

Referring to FIGS. 1-3 there are shown three example scenarios of how the present invention acts to assist in routing call set-up messages through a network. Specifically, FIG. 1 shows a network comprising four telecommunications switches 11a-11d interconnected by a full mesh network of links 13a-13f. Each node comprises, or has access to, respective routing tables 15a-d. Each of the network nodes 11a-11d may support 1 or more links to terminal devices, of which only two are illustrated: two voice terminals 10,12 connected via respective local access links 14a, 14d to nodes 11a and 11d respectively.

In the scenario shown a caller at terminal 10 attempts to make a call to a subscriber at terminal 12. The request is passed via link 14a to the local exchange 11a. The local exchange uses its routing tables and the knowledge of the number dialled by the subscriber along with its knowledge of which network links have free capacity, to route the call set-up request in this case directly 13d to the network node 11d to which the selected remote terminal 12 is directly connected. In this case since the routing of the call set-up message is made from the node at which the call set-up request is first received directly to the node to which the called terminal is directly connected there is no possibility of looping occurring.

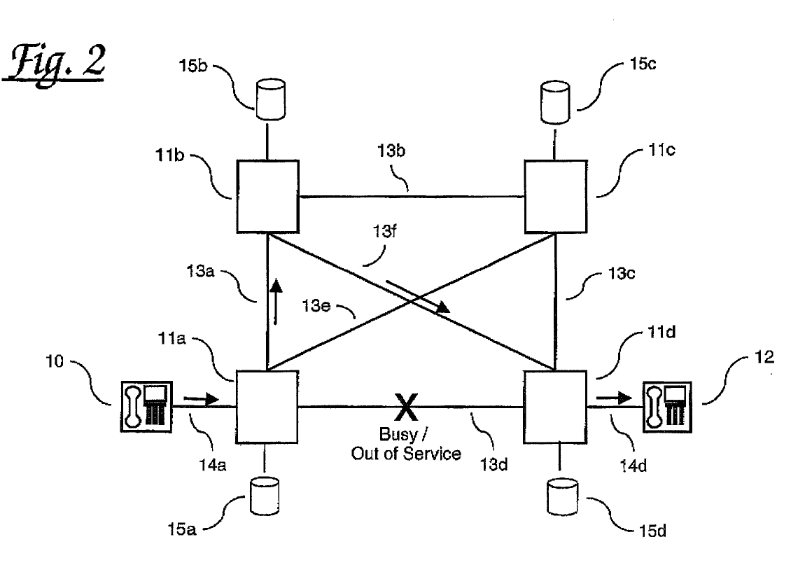

Referring now to FIG. 2 there is shown an alternative scenario in which all the direct links 13d between nodes 11a and 11d are either busy or out of service. It is therefore not possible in this scenario for a call set-up request initiated at terminal 10 to be routed directly between network nodes 11a and 11d. Since the network is connected by a full mesh of links, node 11a has in principle the option of routing the call set-up request either to node 11b or 11c. In the example shown intermediate node 11b is selected (based on routing tables in node 11a indicating a route to node 11d via node 11b) and a call set-up message transmitted via link 13a. In accordance with the invention however the call set-up message transmitted to 11b comprises an indication that the call set-up request has already passed through node 11a.

At node 11b a similar routing process takes place. The routing node has access to routing tables which would typically indicate that a call could be set-up from node 11b to a terminal attached to node 11d by routing the call either directly via link 13f to node 11d or indirectly over links 13a or 13b to nodes 11a and 11c respectively. However comparison of the routing table information with the knowledge contained in the received call set-up request that the call set-up request has already passed through node 11a may be used to prevent the routing of the call set-up request back through node 11a. In this way the looping of call set-up requests directly back to a node from they have been received is automatically prevented. In the example shown the direct route from node 13b to 13d is selected and the call set-up message, now comprising know an indication that it has traversed both nodes 11a and 11b, is sent over link 13f.

At node 11d it is identified that the called terminal 12 is directly attached to that node and no further routing takes place across the network.

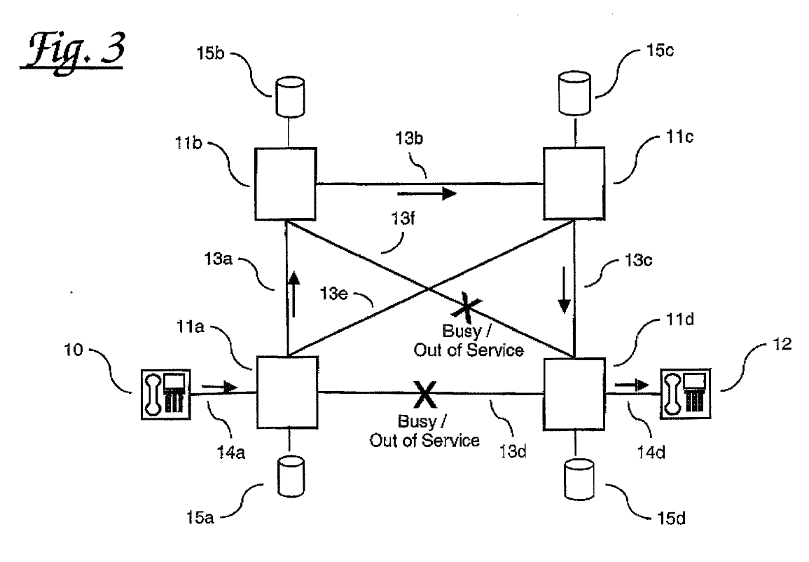

Referring now to FIG. 3 a scenario similar to that shown in FIG. 2 is depicted but with the further complication that the link 13f is busy or out of service at the time the call set-up request is initiated at terminal 10. In this case the process is similar to that of FIG. 2 until the call set-up request is received at node 11b. A similar comparison of the transit information contained in the call set-up message is made as before with the call routing information in node 11b, though this time in conjunction with the information that no direct link from 11b to 11d is available. In this case the call set-up message is forwarded to node 11c, with the transit information in the call set-up message comprising an indication both of node 11a and node 11b as having already been passed through.

Upon receipt at node 11c a similar comparison process takes place. Routing of the message directly back to node 11b is prevented since node 11b is already indicated in the transit information in the received message. As before, this prevents direct looping back to an immediately preceding node. However in this case routing via link 13e to node 11a is also prevented by the same process, since node 11a also appears in the transit information. This then acts to prevent indirect looping back to a node which did not immediately precede the present node. In this case the only possible route by which the call set-up request can be forwarded to the destination node 11d is by the direct fink 13c.

By the inclusion of the transit information in each forwarded call set-up message, subsequent nodes can make intelligent routing choices by avoiding routing to nodes already traversed.

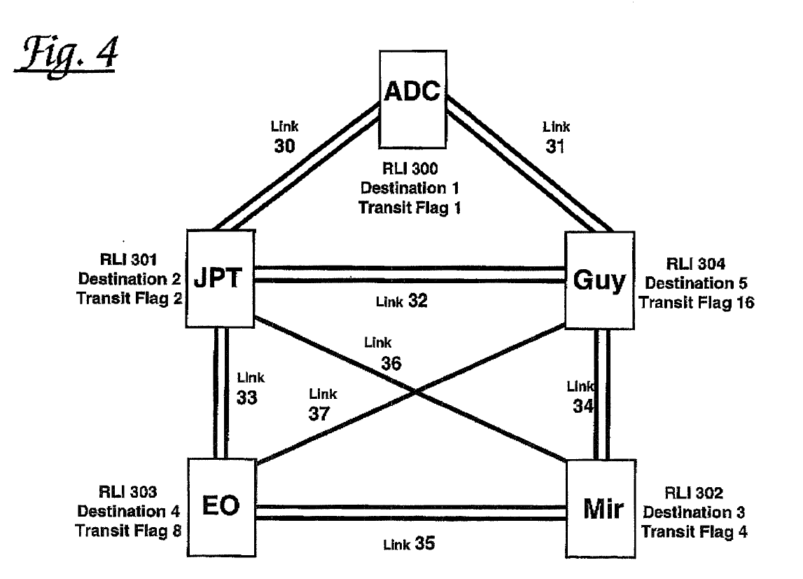

Referring now to FIG. 4, there is shown another example of a network in accordance with the present invention, but having five nodes ADC, JPT, EO, Guy, and Mir. Interconnected by a number of traffic bearing links 30-37. Each node has associated with it a unique identifier (“destination 1”-“destination 5”). used to identify the ultimate destination of call set-up messages, and also a corresponding unique transit flag identifier used when adding transit information to call set-up messages as they cross the network.

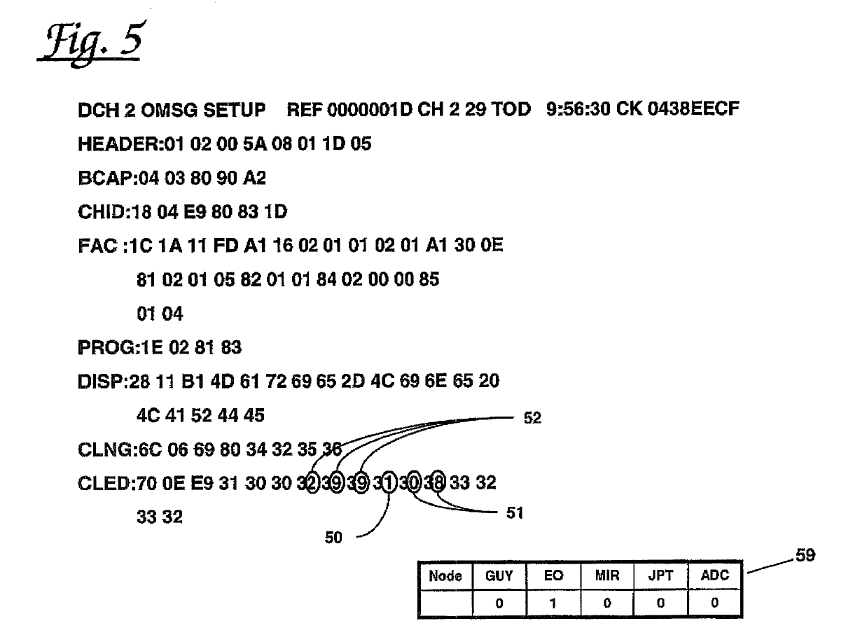

FIG. 5 shows an example data-fill of such a call set-up message. The specific fields of interest are the identification 50 of the destination node (in this case destination node 1 (ADC)) and the transit flag information 51 in this case indicating that the message has already transited node EO indicated by code “8” which corresponds to the bit pattern “01000” used to indicate node EO has been passed through (see detail 59). The transit flag in this arrangement has been reduced to a most basic form of utilizing one bit to denote each of the nodes in the network. The transit flags (1,2,4,8,16) shown in FIG. 4 therefore correspond to successive bits within the transit flag field. A zero bit in the field indicates that the message has not yet transited that node; a one indicates that the message has already transited that node and should not be routed basic through it. This encoding requires only one bit per node and is therefore highly efficient. The destination codes may, but need not, use the same encoding as the transit flags so that the destination code and transit flag for a given node are the same.

The transit flag field itself may be preceded in the encoding by a prefix 52 which serves to differentiate calls made using this routing method from those which do not. In the example shown the prefix “299” has been used.

Whilst in the example described above the transit flag has been set on all occasions when a call set-up message is forwarded, it will be apparent that, where the route chosen is known to be a direct route from the present node to the destination node, it will not be necessary to include the transit information.

As will be apparent to one skilled in the art, the method is not signalling protocol specific and therefore could be deployed in conjunction with any one of a number of standard or proprietary protocols including, but not limited to, Q.931, SS7, DPNSS, CAS, ISDN signalling analogue tie, etc. Furthermore it is not necessary that the same protocol be used on all links—merely that the relevant node transition information be passed on at each point in the network—so that the method can be applied across hybrid networks employing two or more signalling protocols.

In a further embodiment of the invention, especially where networks comprise a large number of nodes, nodes could be clustered together to form groups, with for example 4-6 nodes per group. Routing within each group could then use the method described above, whilst routing between the groups could make use of the same routing scheme but directed only to the routing between groups as a whole, and taking no account of the internal structure of, and therefore routing within, each individual group. In this way the method can be applied in a hierarchical fashion with two or more levels of structuring to address routing in networks of arbitrary size.

Viewed another way, although described as a routing method between nodes in a network, those nodes may themselves comprise a further network of nodes made to appear like a single node for purposes of external communication.

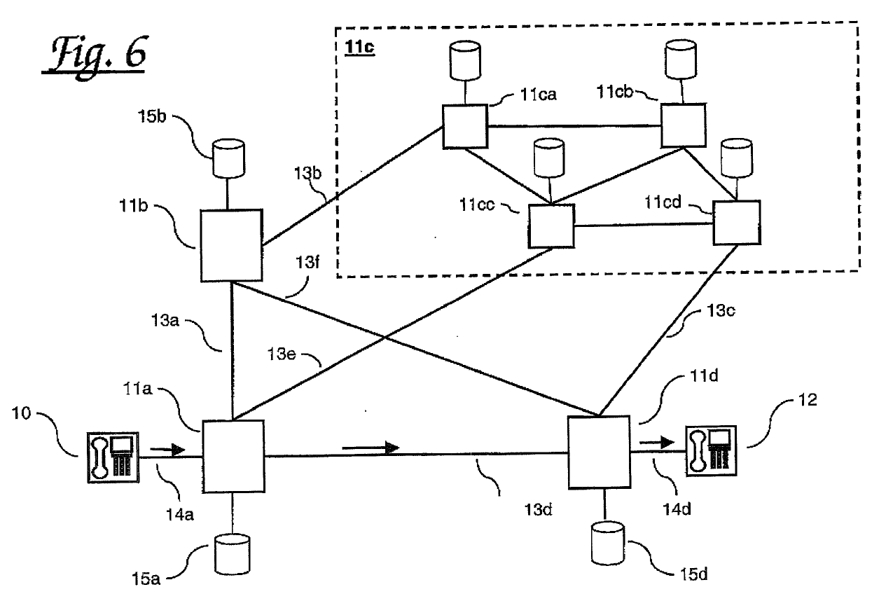

FIG. 6 shows such a hierarchical network, in which node 11c of FIGS. 1-3 itself comprises a subnetwork of four nodes 11ca-11cd each with associated routing tables. In this case the routing tables contain information necessary for both routing within the node 11c, and between node 11c and nodes external to node 11c.

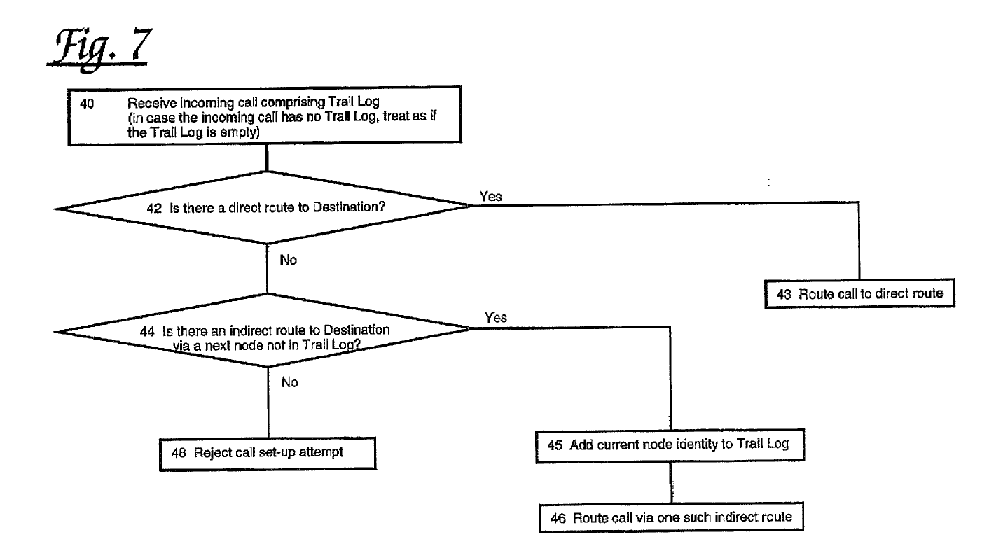

Referring to FIG. 7, the method comprises, at a given node, receiving 40 an incoming call setup request. Typically the request will comprise a trail log indicative of the nodes through which the request has already passed. In the case of a call request having no trail log, this can be considered as having an empty trail log.

If 42 there is a direct route to the destination node listed in the routing tables and currently available, then 43 route the call directly.

If not, identify 44 whether an indirect route is present and available and which does not involve routing immediately to a node listed in the trail log. If so, then add 45 the current node identification to the outgoing call setup request and route it 46 via such a route. If not, then reject 48 the call setup request.

The application of the method is therefore both elegant and straightforward. If a call were to pass through any node more than once, it could be assumed that circular routing had occurred. By setting a “Transit” flag within the call set-up message for each node traversed, subsequent nodes can make intelligent routing choices by discounting routes to nodes already traversed.

The “non-return” flag concept is reduced to the most basic form of setting a bit in a binary word though other encodings could of course be used: 0 for “OK to send” and 1 for “non-return”. So for a four node network a four bit word is required, for a six node network, a six bit word etc.

When the concept was first developed, it was for a four-node network of dissimilar switches using a variety of signalling protocols. The lowest common denominator was the ability of all the switches to achieve digit manipulation on dialled digits and so the signalling method described above was devised

The application of the algorithm above has the virtue of being non-proprietary and can therefore be deployed in a multi-vendor network scenario.

Any range or device value given herein may be extended or altered without losing the effect sought, as will be apparent to the skilled person for an understanding of the teachings herein.

1. A method of routing calls in a telecommunications network routing node, the method comprising the steps of:
receiving a call set-up request comprising an indication of at least one node through which the set-up request has passed;
retrieving previously stored call routing information;
routing the call set-up request responsive to a comparison between the indication and the previously stored call routing information.

2. A method according to claim 1 in which the routing node is a Private Branch Exchange.

3. A method according to claim 1 in which the indication of previously passed nodes comprises a bit sequence, each bit of which uniquely identifies a network node.

4. A method according to claim 1 in which the call set-up request further comprises an indication that the call set-up request relates to a non-primary routed call.

5. A method according to claim 4 in which the indication that the call set-up request relates to a non-primary routed call precedes the indication of at least one node

6. A method according to claim 1 in which the call set-up request further comprises an indication of a destination node distinct from the routing node.

7. A method according to claim 1 in which the call set-up request comprises an indication of at least two nodes through which the set-up request has passed.

8. A method according to claim 1 in which the call set-up request comprises a indication of all nodes through which the set-up request has passed.

9. A method according to claim 1 in which the routing node itself comprises a plurality of component nodes.

10. A method according to claim 1 in which the step of receiving employs a first communication protocol and in which the step of routing employs a second communication protocol distinct from the first communications protocol.

11. A method of routing calls in a telecommunications network comprising a plurality of routing nodes. The nodes being hierarchically structured in at least two levels of hierarchy in which routing of cells employs the method of claim 1 at least at two distinct levels of the hierarchy.

12. A call routing node, for a telecommunications network, comprising:
a port arranged to receive a call set-up request comprising a trail log, from another call routing node;
a store for storing call routing information;
a router arranged to route the call set-up request responsive to a comparison between the trail log and the stored call routing information.

13. A telecommunications network comprising at least one call routing node according to claim 12.

14. A program for a computer in a machine readable form for routing calls in a telecommunications network comprising a plurality of nodes, the program comprising portions arranged to perform the steps of:
receiving a call set-up request comprising a trail log;
retrieving previously stored call routing information;
routing the call set-up request responsive to a comparison between the trail log and the previously stored call routing information.

15. A telecommunications signal comprising a call set-up request comprising a trail log for use in routing the call set-up request.

16. A telecommunications signal according to claim 15 in which the call set-up request further comprises an indication that the call set-up request relates to a non-primary routed call.
